(19) United States
(12) Patent Application Publication
(10) Pub. No.: US 2017/0058450 A1
(43) Pub. Date: Mar. 2, 2017

(54) Novel Socks and Small Clothing Article Organizational Device

(71) Applicants: Anthony Napolitano, Commack, NY (US); David Abecassis, Huntington Station, NY (US)

(72) Inventors: Anthony Napolitano, Commack, NY (US); David Abecassis, Huntington Station, NY (US)

(73) Assignee: Anthony Napolitano, Commack, NY (US)

(21) Appl. No.: 14/833,272

(22) Filed: Aug. 24, 2015

(51) Int. Cl. D06F 95/00; G09F 3/02; G09F 3/16; F16B 2/10; F16B 1/00

(52) U.S. Cl. CPC D06F 95/008; F16B 2/10; F16B 1/00; G09F 3/16; G09F 3/02; F16B 2001/0028; G09F 2003/0282; G09F 2003/0208

(57) ABSTRACT

A series of binder clips are liked together by a flexible rod, or series of rods which can be joined at their extremities to make a ball like lattice for use with the drier. The clips have tactile identifiers for Braille and Non Braille users. They can be removed from the rod and re-attached after socks or pantyhose, or handkerchiefs have been clipped in the attachment points. The clips hold one article each and have raised geometric-figures for non Braille reading users, and Braille beneath for the blind. The rods with clips allow for visually segregated articles of clothing to be washed together, dried together, and arranged together. The tactile identifiers allow for use in the dark without the need for visualization.

### FIELD OF THE INVENTION

The field of the invention is clothing article accessories. The class of the invention is 211-123, “supports or racks”.

### BACKGROUND OF THE INVENTION

Socks and other coordinated clothing items which are small are difficult to see without light, and often get mismatched or lost, both during laundry and storage. In U.S. Pat. No. 7,631,753 Temmel describes a sock clip which stacks the socks vertically and can be washed. In U.S. Pat. No. 7,628,302 Yau describes an accessory rack with a loop system for hanging clothing articles. In U.S. Pat. No. 7,377,409, Brown describes an interlocking hook system for organizing multiple garments. In U.S. Pat. No. 7,058,986 the authors Pietzyk and Hardy describe socks with snap fasteners built into the cuff for attaching socks together. In design U.S. Pat. No. D521,368, the inventor Carl describes a sock system using a channel in the sock within which the mate is threaded to attach the pair. In U.S. Pat. No. 6,837,413 the inventors Raymond et al. describe a clothing article relay attachment system, with plastic sub-components, having string which can interlock in chain-like fashion from the individual fasteners. In U.S. Pat. No. 6,389,657 the inventor Turner describes a sock clip which is used to attach socks together during laundry. The clips have two halves which unite to bond the socks during wash. In U.S. Pat. No. 6,237,158 the inventor Barbara describes a tongue and grove attachment system for socks to bind pairs together. The system also allows for ornaments to be attached to the socks. In U.S. Pat. No. 6,161,263 Anderson describes a membrane attachment system which allows socks to be attached to a common membrane by elastomer elements and then detached for use. In U.S. Pat. No. 5,826,775 Mooney et al describe a hand held clip system which has a handheld perforation blade for adding on a clip and a clip cutting blade near the handle. The device is used to attach clips to socks so that they can be interlocked afterwards. In the case of U.S. Pat. No. 5,440,791 the inventor Guio describes a clip which is an elongated C-clamp configuration made of non metallic material as to be used in the dryer. Guio describes different colors to identify the pairs of socks attached to each individual clip.

In the ornamental U.S. design Pat. No. D353,245 the inventor, Tucker, describes an ornamental design with a release button for the sock clip. The raised lettering would allow you to feel the word “push”, which is claimed in the design.

In U.S. Pat. No. 4,503,591, the inventors Adamska and Koperska describe a ring which pierces socks and keeps them together during wash and storage. The ring closes at the top via a loop and hook mechanism.

Finally, the inventor Fuller in U.S. Pat. No. 3,972,094 describes a box storage device with a system of clips. The box has separators in the form of interior compartment walls.

All of the prior art deals with the need to arrange socks and small articles as well as their storage and laundry. Nothing in the prior art reviewed deals with low light or dark conditions in distinguishing individual pairs of clothing.

### OBJECTS OF THE INVENTION

One object of the invention is to develop a new clipping system for paired or small clothing articles such as socks, handkerchiefs, or gloves. Yet another object of the invention is to invent a washable clipping and pairing system for paired or small clothing articles such as socks, handkerchiefs, or gloves. Yet another object of the invention is to invent a clipping system for paired or small clothing articles such as socks, handkerchiefs, or gloves, which allows the user to distinguish the different articles in the dark or low light conditions. Yet another object of the invention is to develop a system of clothing clips which can be distinguished in Braille by the visually impaired. Another object of the invention is to develop a washable and storage friendly system for paired small clothing articles such as socks, handkerchiefs, or gloves. Yet another object of the invention is to minimize noise of the storage device with attached clothing items in a dryer.

### SUMMARY OF THE INVENTION

The invention is a system of clips which can be manually distinguished in dark conditions or by the visually impaired. The clips have a combination of geometric shapes on their facing up surfaces which are easily distinguished by touch for non Braille readers, and Braille for Braille readers.

### DETAILED DESCRIPTION OF THE INVENTION

A series of one and half inch clips which are half an inch wide have raised geometric figures on their upward faces in addition to Braille letters, also raised on the upper surface.

When the cloths are washed, the ensemble can be placed in the washer with the clothes clipped to the device, and removed after wash with all articles still attached. Since the clips are removable, the items can also be washed separately. In all cases, the paired socks or handkerchiefs or washable gloves can be distinguished by pairing a given item with a raised geometric shape on the clip.

### EXAMPLES OF THE INVENTION

In one preferred embodiment of the invention flat headed clips which are one half inch wide and and an inch and a half long and have a tail which clips them to the rod. The rod has a central hole for one rod which holds a complementary peg.

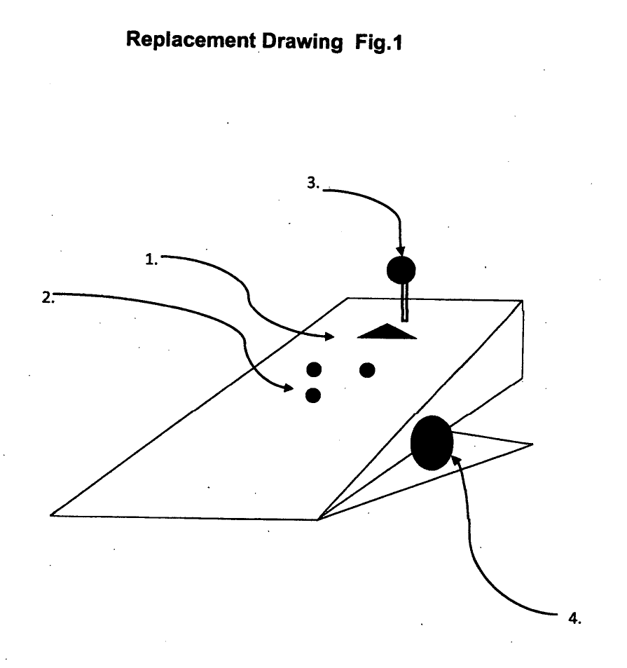

In FIG. 1. The basic element of the invention, the tactile clothing pin is shown with its docking insertion tail protruding from the back of the clip, as well as the tactile geometric and Braille identifiers on the face of the clip.

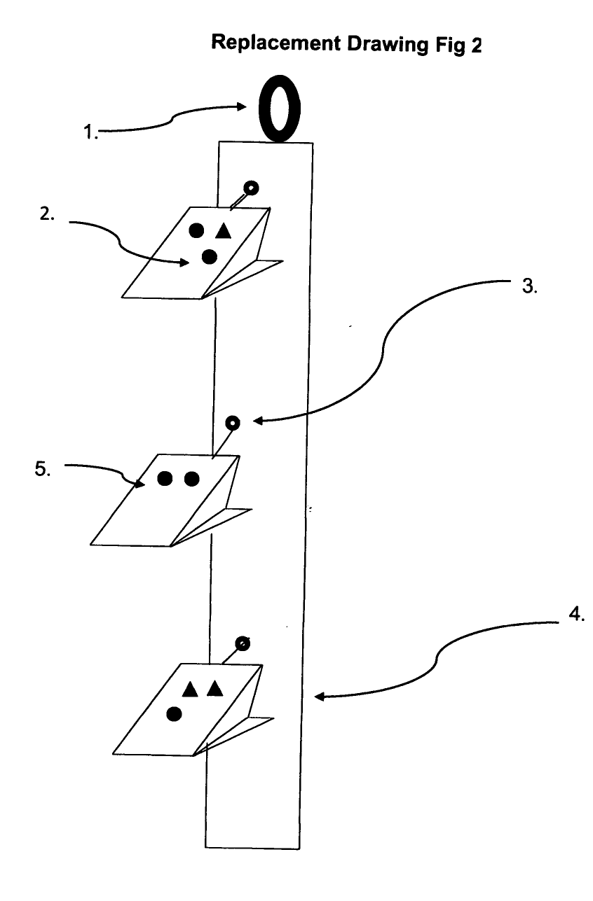

In FIG. 2 the invention is shown with the clips docked to a solid strip which has polymer docking donuts for the tail of the clip to be reversibly embedded.

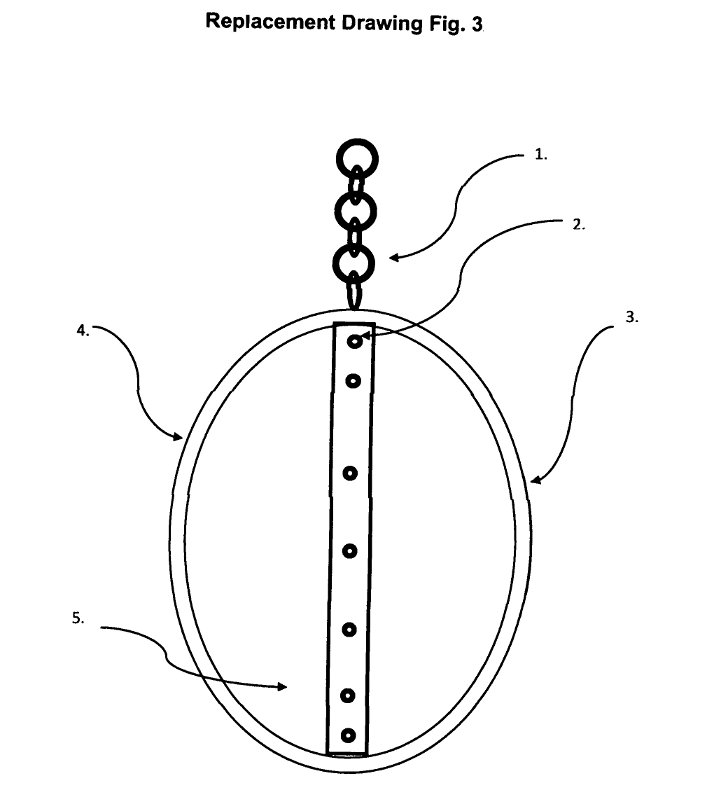

In FIG. 3. The strip in this figure has a loop so that it can be hung up on hooks or clothes lines for drying the clipped clothing articles, such as socks. The docking systems can vary, and some variations of the strip model, can be combined into a bi-loop for ball like properties in the dryer of better drying density on clothes lines for less use of space. In this invention there can be several types of docking systems depending upon utility. As long as it posses the clip polymer donut docking heads on it's surface, then the tactile identified clips can be docked and allowed to suspend the clothing items after docking reversibly via the insertion of the bulb at the end of their docking tail, with the donut. This keeps the insertion under tension, and imposes force for the clips' removal.

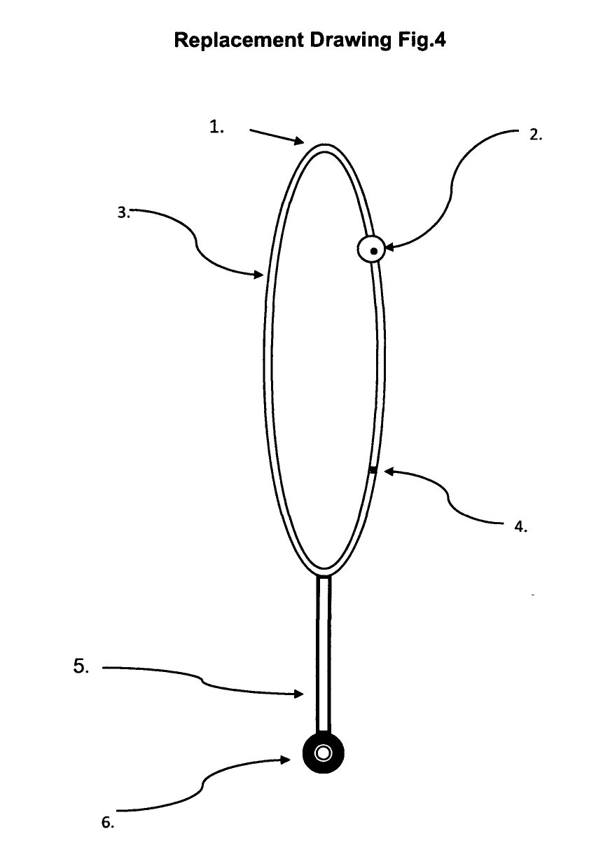

In FIG. 4. The invention docks into a carabineer clip styled narrow loop for single item hanging on a line or hook. The carabineer styled narrow loop allows for good stability, even in high winds. The basal polymer donut allows for clips with clothing articles to be rapidly interchanged and quickly hung up by the user.

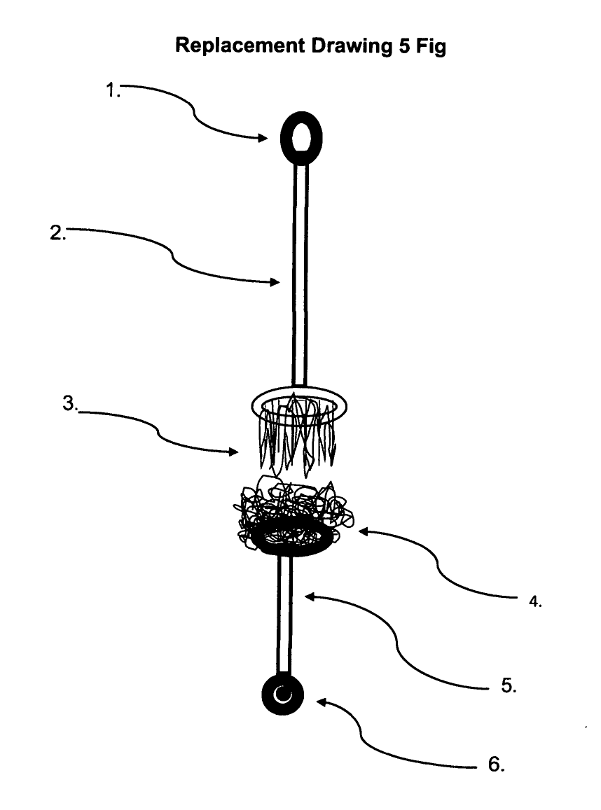

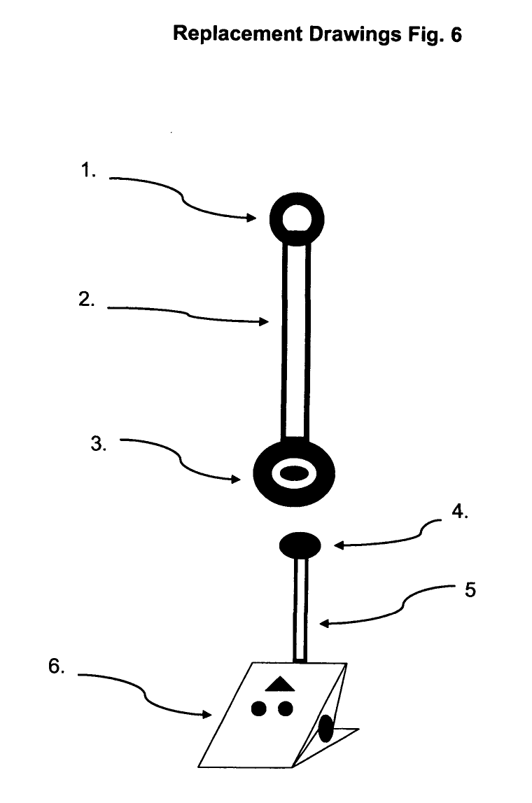

FIG. 5 illustrates the use of using polymer or plastic micro-hooks with a non-woven binder to allow the docking assembly to be quickly disassembled and the clothing item exchanged for another. In this embodiment of the invention the rod is configured with a superior half which remains on a line or hook, and the inferior portion has a basal docking polymer donut. This can be simplified as is seen in FIG. 6 to a loop and a rod and a lower polymer docking donut.

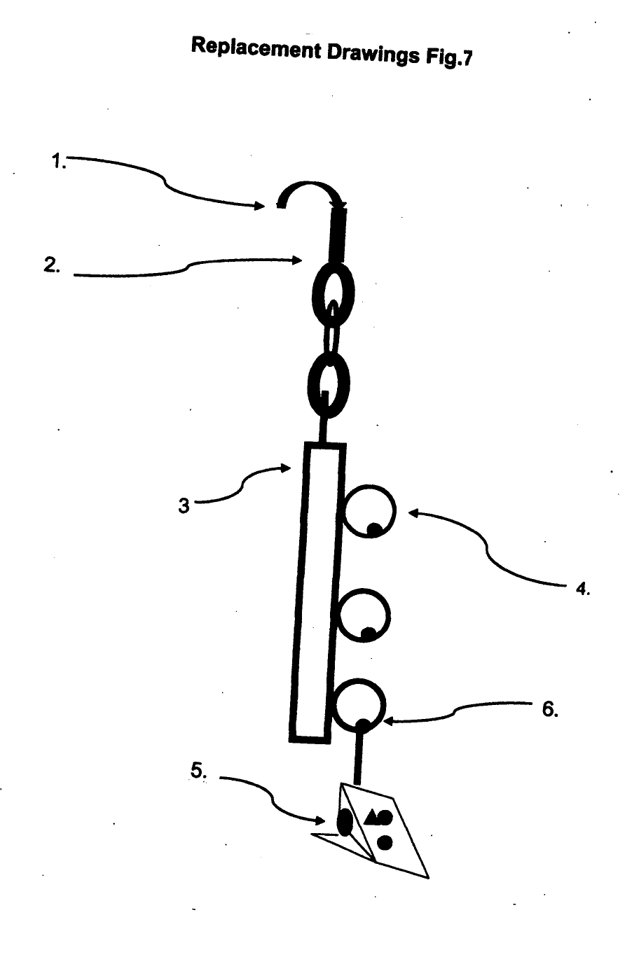

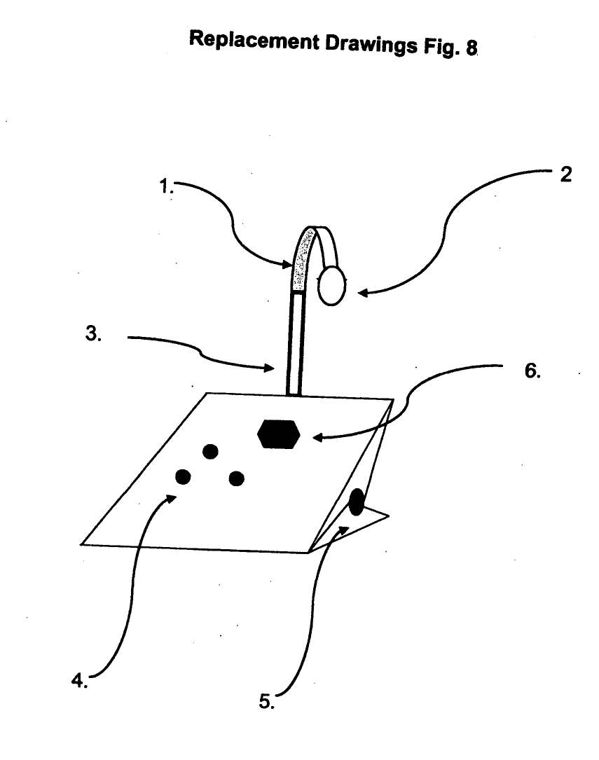

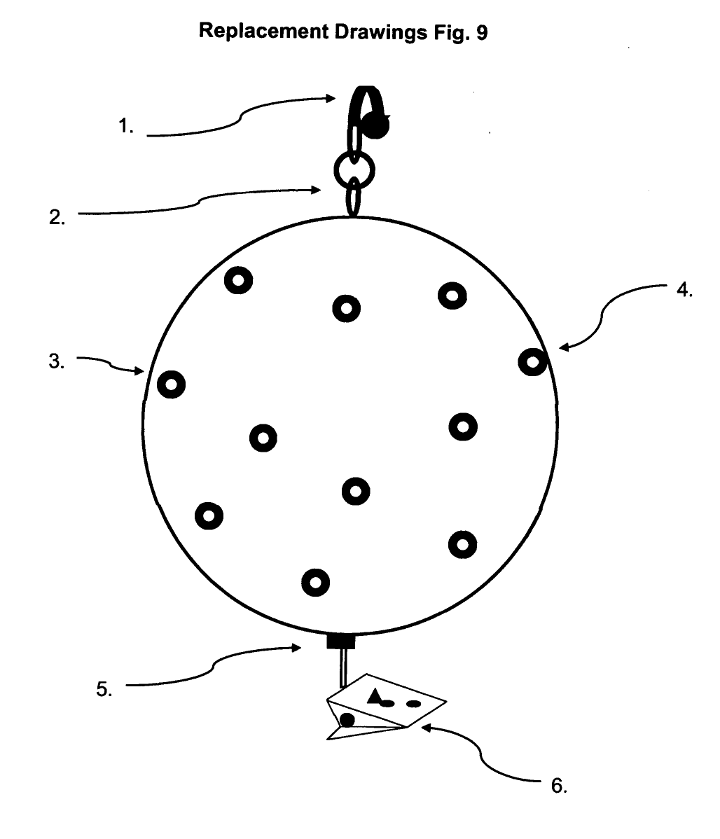

For clothes line use the assembly, such as a rod FIG. 7 shows a chain suspended rod with polymer docking donuts on one side, which allows the orientation of articles facing one direction, and ease of removal of the rod by unhooking from the hanging support. The clip itself can be modified to have an individual hook at the end of the tail, for individual article drying or hanging up, but as FIG. 8 shows, the hook can terminate by a docking bulb for inserting into the polymer docking donut on an assembly device holding more than one clip. As stated several forms of docking assembly devices for the clip are possible. FIG. 9. Shows a ball configuration with the clips held to the surface by polymer donuts. The ball can be hollow or solid, but by having the clothing articles clipped to it's outside surface, the clothing articles can dampen noise from dryer impact generated sounds.

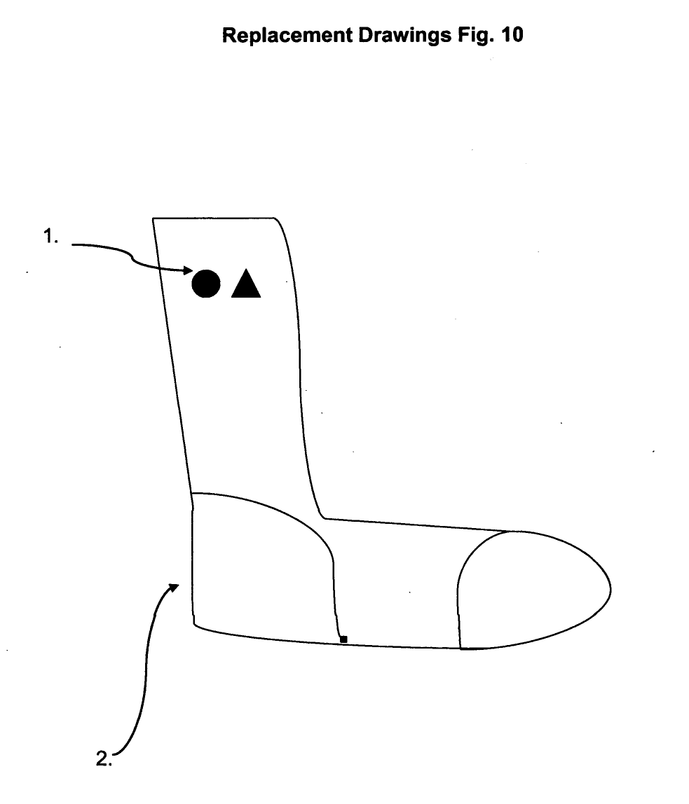

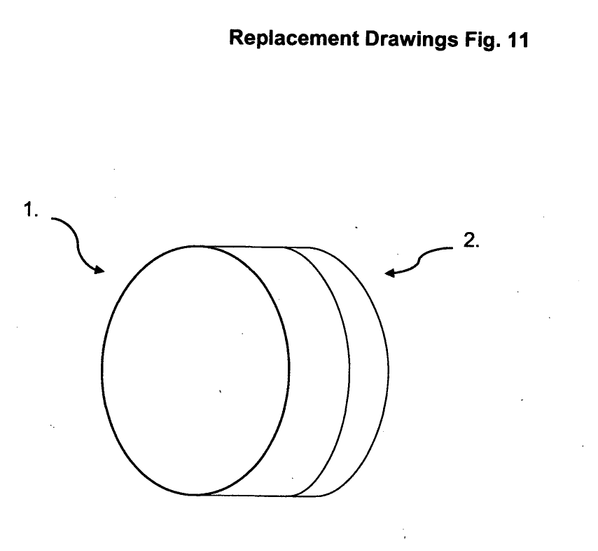

FIG. 10 shows the identifier which is attached to a sock using hot melt adhesive. The tactile identifier stays on the article allowing it to be matched quickly without the need for sight. This allows for pairing with the clip system. The identifier itself consists of a two polymer layer geometric or Braille containing tactile surface placed over a layer of hot melt lower weight polymer. When heat is applied, the hot melt adhesive binds the element to the sock or other article of clothing. This is illustrated using a circular element in FIG. 11.

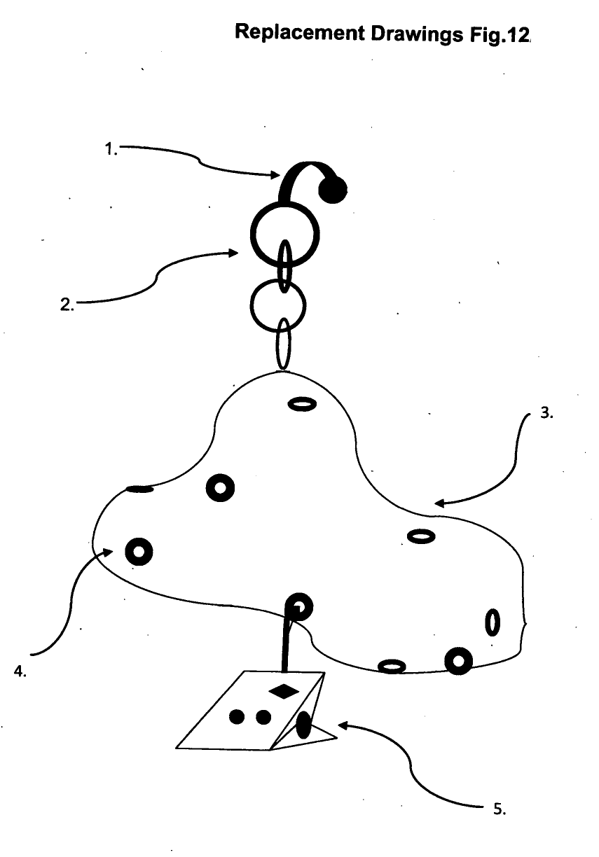

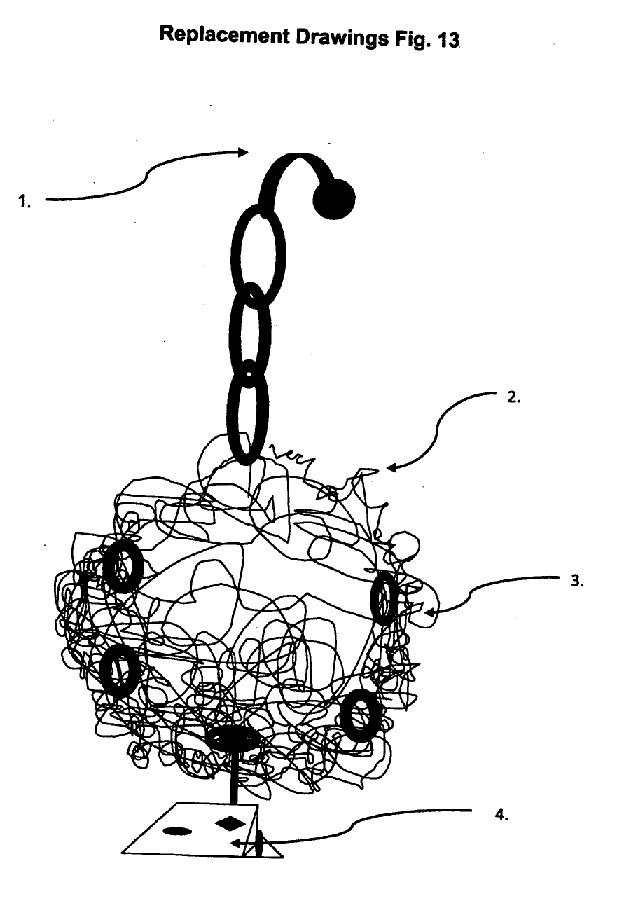

To lessen impact and dampen noise even further if the assembly is placed in a dryer. To this end the polymer donuts can be placed over a bead filled amorphous bag which absorbs impacts. FIG. 12 shows such an embodiment of the invention with a bulb tipped hook for both docking with donuts and being hung up easily and taken off easily. This can be taken further by using a polymer nonwoven ball which drains easily as well as dampening noise if used in the dryer. This is illustrated in FIG. 13

1) The use of raised geometric shapes and Braille on clips for clothing pairing for small clothing items such as socks, handkerchiefs, and washable gloves for storage and washing and drying.

2) The use of raised geometric shapes and Braille on clips for clothing pairing for small clothing items , for storage and washing and drying, which attach and detach to a bar or rod which allow the clothing items to be grouped during wash, drying and subsequent storage.

3) The claim in 2 where the rods are flexible and can be attached at their extremities to form reversible loops which combined, form a ball like configuration with the clothing articles facing the outside during ball configuration.

4) The claim in 2 where more than one rod can be joined in the center of the rod via a hole and peg configuration which allows the rods to be detached and stored separately if need be, or reconfigured with the clothing articles facing in opposite directions for washing the entire unit with the clothes attached.

5) The claim in 4 where the unit can also be assembled and fixed into a ball using the same components with the ends attached, via loop and hook fixing, with the clothes facing outward, for dryer noise attenuation.

6) The claim in 4 where the unit can also be assembled and fixed into a hollow ball, with multiple surface perforations using the same components with the ends attached, via loop and hook fixing, with the clothes facing outward, for dryer noise attenuation.

7) The claim in 1 where the clip is attached to an amorphous bag filled with polymer beads.

8) The use of a hot-melt adhesive backed tag to attach a geometric figure and Braille to socks for matching with the clips in claims 1-7.

9) The claim in 3 where the attachment of the extremities is made by a loop and hook.

10) The claim in 3 where the attachment of the extremities is made by a hook and nonwoven polymer combination.

11) The claim in 3 where the attachment of the extremities is made by a carabineer clip.

12) The claim in 3 where the attachment of the extremities is made by a ball and ball-pocket made of elastic polymer.

13) The claim in 1 where the clips and the brail-geometry identifier are magnetized and can hold together using magnetic force, and be disjoined by human hand strength.
